(19) United States
(12) Patent Application Publication
(10) Pub. No.: US 2026/0034699 A1
(43) Pub. Date: Feb. 5, 2026

(54) PUNCH FOR A POWER TOOL

(71) Applicant: Milwaukee Electric Tool Corporation, Brookfield, WI (US)

(72) Inventors: Eric Lembach, Brookfield, WI (US); Jean Mauricio Uruena Montoya, Wauwatosa, WI (US); Eli Kindomba, Brookfield, WI (US); Patrick Jalabert, Brookfield, WI (US); Zachary Geschke, Brookfield, WI (US)

(21) Appl. No.: 19/283,537

(22) Filed: Jul. 29, 2025

Related U.S. Application Data
(60) Provisional application No. 63/677,236, filed on Jul. 30, 2024.

(51) Int. Cl. B26F 1/34

(52) U.S. Cl. CPC B26F 1/34

(57) ABSTRACT

A punch is provided, such as can be used with a knockout punch tool to make a hole in a workpiece. The punch has a base including a first material and a plurality of teeth extending from the base. Eash of the plurality includes a body and a tip and the plurality of teeth include a second material having a material property that is different from the first material.

### CROSS-REFERENCE TO RELATED APPLICATIONS

This application claims the benefit of U.S. Provisional Patent Application No. 63/677,236, filed Jul. 30, 2024, which is incorporated herein by reference in its entirety.

### BACKGROUND

Power tools use punches or dies to create an opening in a workpiece. The die can be used to make holes of various sizes in materials having a wide range of thickness, such as metal, plastic, wood, etc. Accordingly, there is a need for dies and punches that are durable and resistant to wear.

### SUMMARY

Aspects of the present disclosure provide a punch for a power tool or device that is used to punch a hole through a workpiece (e.g., a sheet material). Punches can include multiple materials that can improve tool life and performance. For example, teeth of a punch can include wear-resistant materials on a cutting surface or cutting edge. The wear-resistant material can be attached to a base material in a variety of ways including mechanical fasteners, metallurgical joining processes (e.g., welding, brazing, soldering, vapor deposition, etc.), adhesives, etc. In some cases, the base material can include retaining features (e.g., grooves, cutouts, chamfers, etc.) to provide a more secure connection between the base material and the wear-resistant material.

In some aspects, the punch includes a base having a first material and a plurality of teeth extending from the base. Each of the plurality of teeth having a body including a first material and a tip including a second material that has a property that is different from the second material. In some embodiments, the first material has a hardness, density, or tensile strength that is different from the second material. In some embodiments, the plurality of teeth includes an angled surface that engages a workpiece. In some embodiments, the angled surface includes a radially outer most edge that defines a cutting edge. In some embodiments, the tip is metallurgically joined with body. In some embodiments, the second material is a hardened form of the first material. In some embodiments, the second material is laser hardened, flame hardened, induction hardened, or electron beam hardened. In some embodiments, the first material includes a hardenable steel alloy that includes at least one of carbon steel, boron steel, alloy steel, or tool steel. In some embodiments, the first material includes carbon fiber. In some embodiments, the second material comprises a carbide including at least one of tungsten carbide, chromium carbide, molybdenum carbide, vanadium carbide, titanium carbide, niobium carbide, tantalum carbide, hafnium carbide, or zirconium carbide.

In some aspects, the punch includes a bottom layer including a body and a plurality of teeth. The bottom layer is includes a first material. The punch further includes a top layer coupled to the bottom layer. The top layer defining an angled surface. The top layer including a second material having a material property that is different from the first material. In some embodiments, the top layer is coupled the bottom layer via a cladding material. In some embodiments, the cladding material is a metal powder. In some embodiments, the punch further includes a buffer layer positioned between the top layer and the bottom layer. In some embodiments, the buffer layer is nickel. In some embodiments, the first material has at least one of hardness, density, or tensile strength that is different from the second material.

In some aspects, the punch includes a base including a first material, the base defining a retaining, and a plurality of teeth extending from the base. Each of the plurality of teeth including a body and an angled surface. Each of the plurality of teeth including a second material having a material property that is different from the first material. In some embodiments, the retaining feature includes a first chamfered surface at a first angle. In some embodiments, the retaining feature includes a second chamfered surface extending from the first chamfered surface, the second chamfered surface at a second angle. In some embodiments the retaining feature is a concave region.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an axonometric view of a power tool according to aspects of the present disclosure.

FIG. 2 is an exploded view of a punch assembly for use with the power tool of FIG. 1.

FIG. 3 is an axonometric view of a punch for use with the punch assembly of FIG. 2, according to an aspect of the disclosure.

FIG. 4 is a cross-sectional view of the punch of FIG. 3, taken through line IV-IV.

FIG. 5 is an axonometric view of another punch for use with the punch assembly of FIG. 2, according to another aspect of the disclosure.

FIG. 6 is a side view of the punch of FIG. 5.

FIG. 7 is a cross-sectional view of the punch of FIG. 5, taken through line VII-VII.

FIG. 8 is an axonometric view of another punch for use with the punch assembly of FIG. 2, according to another aspect of the disclosure.

FIG. 9 is a cross-sectional view of the punch of FIG. 8 taken through line VII-VII . . .

FIG. 10 is an axonometric view of a punch for use with the punch assembly of FIG. 2, where the punch has a retaining feature according to another aspect of the disclosure.

FIG. 11 is a cross-sectional view of the punch of FIG. 10 having a retaining feature, taken through line XI-XI.

FIG. 12 is a detail view of the cross-sectional view of the punch of FIG. 11, taken about line XII-XII.

FIG. 13 shows a axonometric view of a punch for use with the punch assembly of FIG. 2, where the punch has a retaining feature according to another aspect of the disclosure.

FIG. 14 is a cross-sectional view of the punch of FIG. 13 having a retaining feature, taken through line XIV-XIV.

FIG. 15 is a detail view of the cross-sectional view of the punch of FIG. 14, taken about line XV-XV.

FIG. 16 is a axonometric view of a punch for use with the punch assembly of FIG. 2, according to another aspect of the disclosure.

FIG. 17 is a is a cross-sectional view of the punch of FIG. 16taken through line XVII-XVII.

FIG. 18 is a flowchart of a method of manufacturing a punch of a power tool according to some embodiments of the invention.

### DETAILED DESCRIPTION

Disclosed embodiments will now be described more fully hereinafter with reference to the accompanying drawings, in which some, but not all of the disclosed embodiments are shown. Indeed, several different embodiments may be provided and should not be construed as limited to the embodiments set forth herein. Rather, these embodiments are provided so that this disclosure will be thorough and complete and will fully convey the scope of the disclosure to those skilled in the art.

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus <10% of the particular term and “substantially” and “significantly” will mean plus or minus >10% of the particular term.

As also used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

The disclosed punch will be described with respect to an example power tool (e.g., a hydraulic power tool). However, it should be understood that any one or more example embodiments of the disclosed punch could be incorporated in alternate forms of a power tool, for example the punch can be used with a manual power tool or a ratchet power tool. Furthermore, it should be understood that one or more example embodiments of the disclosed punch could be used outside of the context of a hydraulic power tool and could more generally be used in a mechanism and/or mechanisms that generate/generates cutting forces.

In one example, the punch described below is configured to be paired with a die and used with a power tool by a user to create openings in a variety of materials. For example, a hydraulic power tool used with the punch as disclosed herein may permit a user to create openings in a panel, such as a panel of an electrical box or the like.

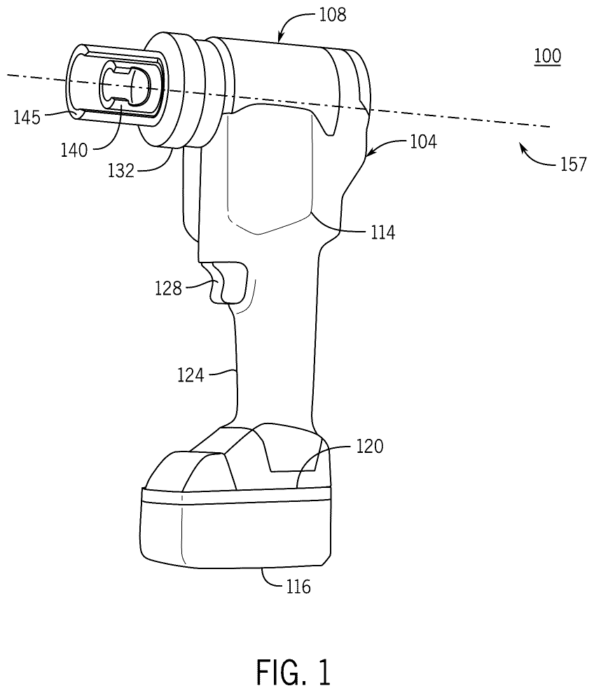

FIG. 1 illustrates a non-limiting example of a power tool 100 according to aspects of the disclosure. As illustrated, the power tool 100 is configured as a power tool, but the principles described herein can also be applied to other types of power tools. In general, the power tool 100 can include a tool body 104 and an output assembly 108 secured to (e.g., above) the tool body 104. The tool body 104 can have a clamshell construction with a first half and a second half that are joined together, or it can be a unitary body. In either case, the tool body 104 can define an interior space in which various components of the power tool 100 can be housed.

In particular, the tool body 104 can include a motor housing 114 configured to house a motor (e.g., a brushless DC motor) that can be operatively coupled to supply a torque to the output assembly 108. The motor can be powered by a power source 116. In the illustrated example, the power source 116 is configured as a battery, and more specifically a lithium ion battery. The power source 116 can be coupled to the tool body 104 at connection port 120, which is positioned at a bottom of the tool body 104. In other cases, different types of power sources can be provided, including, for example, a power cord configured to supply AC electrical power.

To control a flow of power to the motor, the tool body 104 can further include a user interface, here, configured as a handle 124. The handle 124 can provide a location whereby a user can grip and manipulate the power tool 100. Additionally, the handle 124 can include one or more triggers 128 to control the flow of power from the power source 116 to the motor. For example, depressing a trigger 128 can send a signal to a controller. The controller can receive the signal and control the flow of power from the power source 116 to the motor.

Supplying power to the motor can cause the motor to spin to supply a torque to the output assembly 108 to cause a hole forming operation. To that end, the output assembly 108 can define an output end 132 that is configured to couple to a punch or die (hereinafter “punch”), which engages a workpiece to form hole therein. It is appreciated that the punch can be a replaceable punch that can be changed out as the punch wears from use or to form differently sized or shaped holes in the workpiece. As illustrated, the output end 132 includes a ram 140 (e.g., a hydraulic ram, electric ram, etc.) that is movable along a axis 157 (e.g., a drive axis) to perform a punch or other work operation. An anvil 145 is provided around the ram 140, to provide counterforce during a punch operation. The anvil 145 may rotate relative to the ram 140, and in some cases, can help retain a punch assembly on the ram 140.

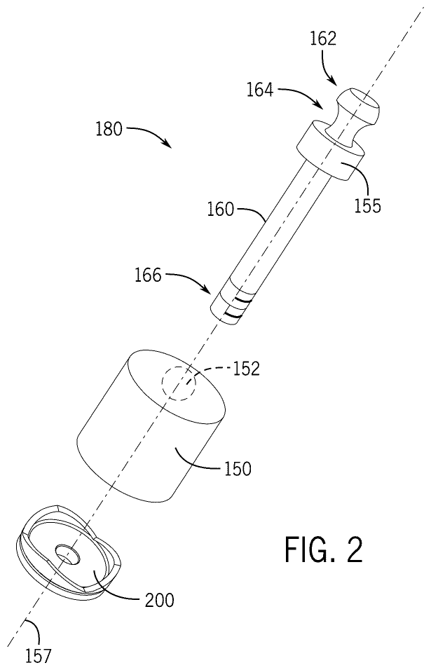

With additional reference to FIG. 2, the power tool 100 can be fitted with a punch assembly 180 to create a hole (e.g., a circular or other shape of hole) in a workpiece, (e.g., a panel or sheet material). The punch assembly 180 includes a draw stud 160 that is configured to couple to a ram 140 of the power tool 100. The draw stud 160 may define a first end 162 and a second end 166 that is positioned opposite to the first end 162. The first end 162 can include a coupler 164 that is configured to couple to the ram 140. The second end 166 may be threaded. The axis 157 extends along the draw stud 160 in a direction between the first end 162 and the second end 166. The draw stud 160 can be coupled to the ram 140 via a quick connect interface, threaded interface, etc. A die 150 can be coupled to the first end 162 of the draw stud 160. In some cases, the die 150 defines a recess 152 having a first cross-sectional shape taken perpendicular to the axis 157 of the draw stud 160. In some cases, the die 150 is moveable relative to the draw stud 160, and may be retained on the draw stud 160 by a fastener (e.g., a collar, set screw, etc.). In one example, the fastener may be a collar 155 coupled to the first end 162 of the draw stud 160. In some cases, the draw stud 160 passes through a center hole of the die 150. In some cases, the draw stud 160 is moveable relative to the die 150 along the axis 157. The die 150 can engage the anvil 145 or a workpiece during a work operation. Accordingly, the die 150 can transmit force between the workpiece and the anvil 145. During a work operation, the draw stud 160 can be moved relative to the die 150 by the ram 140 between a first position and a second position.

The punch assembly 180 can further include a punch 200 that can be coupled to the second end 166 of the draw stud 160 so that the punch 200 is coupled to the power tool 100 via the ram 140. In some cases, the punch 200 is coupled to the draw stud 160 so that the die 150 is between the punch 200 and the collar 155. Accordingly, the punch 200 can move with the draw stud 160 and the ram 140. As the ram 140 moves, the punch 200 is moved towards the die 150. In some cases, the punch 200 is moveable with the draw stud 160 relative to the die 150 so that the punch 200 is received in the recess 152 of the die 150 to cause a punch in a workpiece. The punch 200 and the die 150 are sized relative to one another so that material of the workpiece that is between the punch 200 and the die 150 is sheared or cut, thereby creating a punch. For example, the punch 200 can be sized to be received in the die 150, or vice versa.

In an example work operation, the draw stud 160 is braced between the anvil 145 and a first side of the workpiece, the punch 200 is positioned in a second side of the work piece opposite the first side. The die 150 is positioned on the first side of the work piece. The workpiece can define a pilot hole that allows the draw stud 160 to pass through the workpiece to connect with the punch 200. When a user activates the trigger 128, the ram 140 is moved and causes the punch 200 to move toward the die 150. The punch 200 may include teeth or other cutting features to allow the punch 200 to move into and through the second side of the workpiece, moving past the die 150, creating a hole having the shape of the punch 200. The material removed from the workpiece is captured between the punch 200 and the die 150.

According to aspects of the disclosure, a punch (e.g., the punch 200) can be configured as a multi-material punch that includes wear resistant materials on wear surfaces (e.g., teeth of a punch) to improve punch longevity and maintain cut quality over time. The configuration of the different materials may be different depending on the specific cutting operation being performed (e.g., workpiece material type, hole size, etc.). Correspondingly, it is appreciated that the various examples of punches described herein can each be used with the power tool 100 and punch assembly 180. It is also appreciated that the features of the exemplary punches described herein can be combined in various ways to optimize cut performance.

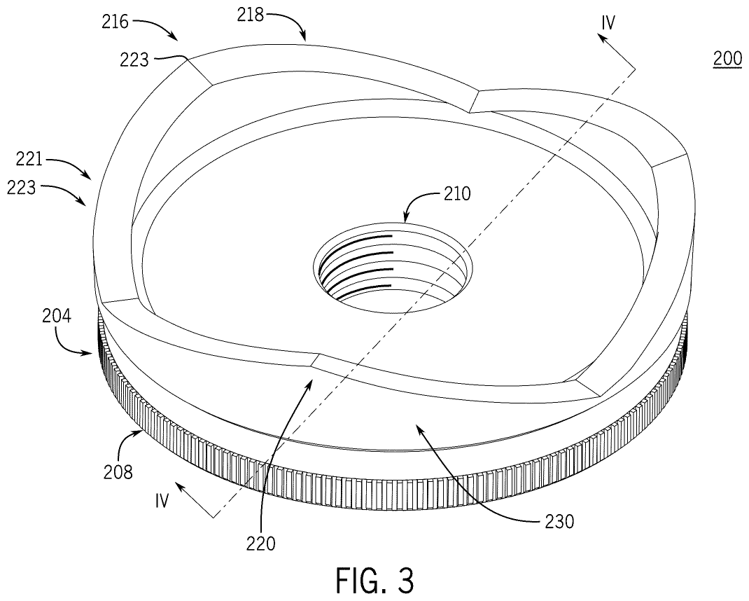

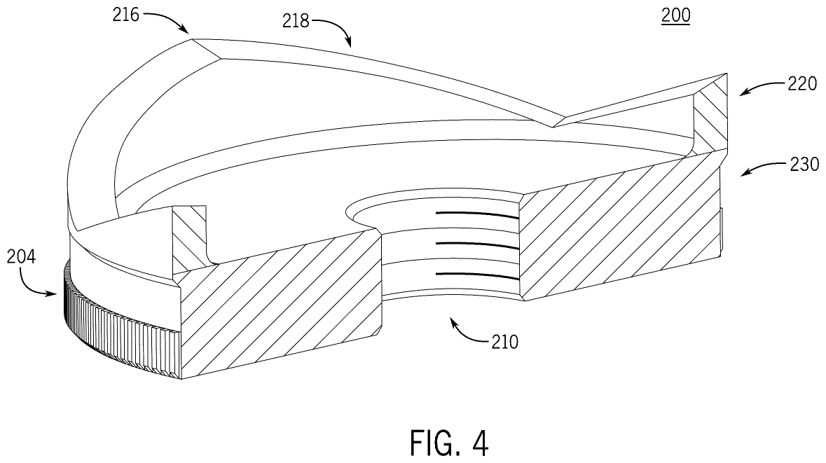

FIGS. 3-4 show an example of punch 200. The punch 200 can include a base 204 that is configured to couple to the output end 132 (e.g., via a connection with the draw stud 160). An external surface 208 of the base 204 can have a texture to improve the grip when grasped by the user, for example, during installation or removal of the punch 200. The punch 200 can include a hole 210 (e.g., a center opening) that passes through the base 204, which can serve as an interface to couple the punch 200 to the output end 132 (e.g., via the draw stud 160). The punch 200 can further include a set of teeth 216 extending from the base 204. The teeth 216 act as cutting surfaces (e.g., wear surfaces) that engage with the workpiece to form a hole therein. The quantity or shape of the teeth 216 can be varied for a particular application (e.g., a size of hole or material of the workpiece). In the illustrated non-limiting example, the teeth 216 are formed as pointed projections with arcuate edges; however, other shapes are possible. As shown in FIG. 3, the punch 200 can include three teeth 216. In other examples, the punch 200 can include one or more teeth 216. The teeth 216 can be spaced evenly about the perimeter (e.g., circumference) of the base 204.

In some examples, a tooth 216 (e.g., one of the set of teeth 216 can be shaped as shown in FIG. 3, where the tooth 216 includes at least two angled surfaces 218 (e.g., cutting surfaces) that are angled relative to one another to form a cutting edge 219. The angled surfaces 218 can also be sloped in, for example, the radial direction, so that the outermost edge 221 (e.g., an edge furthest from a base defines the cutting edge 219. The angled surfaces 218 extend away from the base 204 and join at a vertex 223 forming a tip (e.g., a cutting tip) of the tooth 216. The angled surfaces 218 include (sharp) edges for effective cutting of the workpiece. In use, the teeth 216 are pressed against the workpiece in which a hole is being made.

To improve wear resistance, the tooth 216 can be configured as a multi-material tooth having a top component 220 (e.g., a tip). The top component 220 includes a material having a density or tensile strength different from the material of a bottom component 230 (e.g., a body or base) that supports the top component 220 on a base (e.g., the base 204). The top component 220 is positioned on regions the punch 200 (e.g., leading surface, edges, or other cutting features) that engage the surface of the workpiece (e.g., the cutting edges) to perform a punch.

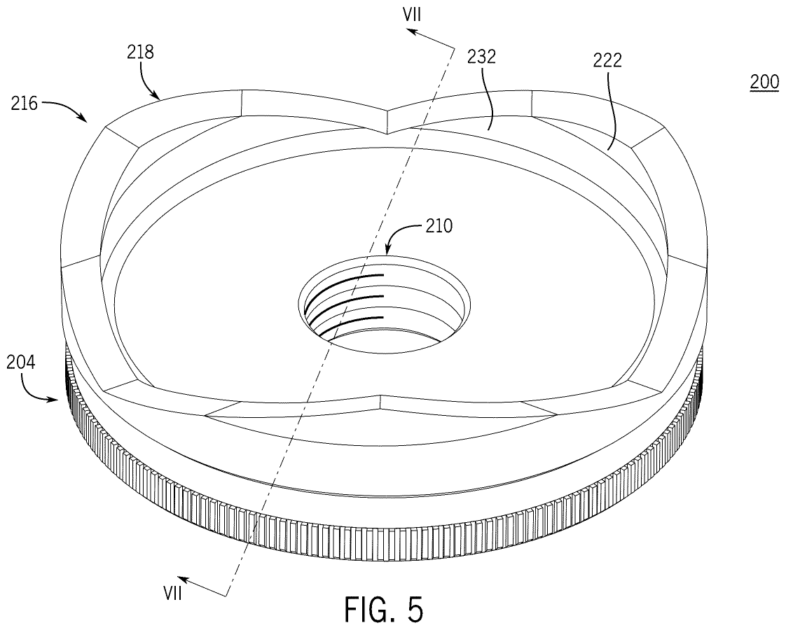

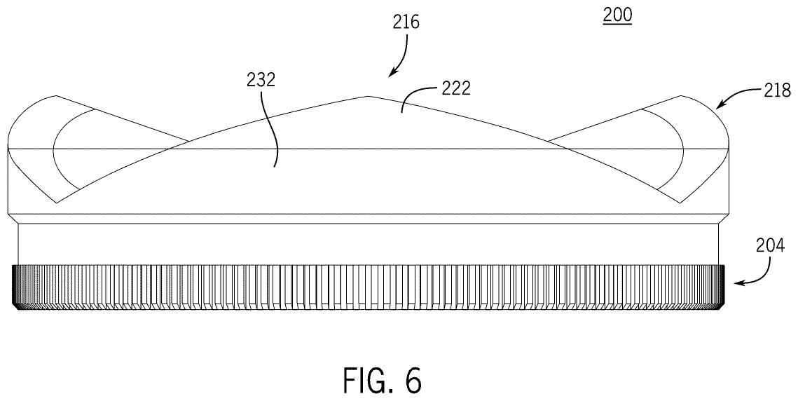

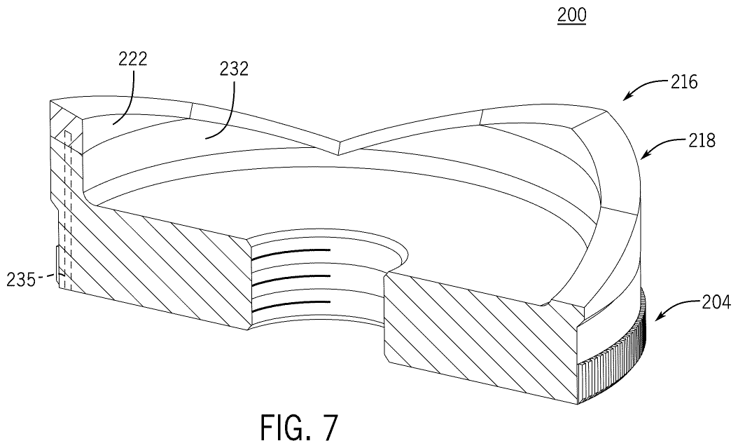

In some examples the punch 200 can be made of two or more materials. In the example shown in FIGS. 5-7, the tooth 216 includes two materials. The arrangement of the two materials can be seen in the cross-sectional view of FIG. 7. The tooth 216 can include a body 232 and a tip 222 that is supported on the body 232. The body 232 is made of a first material and the tip 222 is made of a second material. The first material and the second material can be different metals or alloys. In some examples, the first material can be alloys of steel, aluminum, magnesium, or titanium. In other examples, the first material can include steel alloys of iron, chromium, cobalt, vanadium, carbon, tungsten, and combinations thereof. Additionally, and alternatively, the first material can include a hardenable steel, such as carbon steel or boron steel, alloy steel, or tool steel. As used herein, “hardenable steel” refers to any type of steel that includes >0.3% carbon and/or <1% boron. In some examples, the first material can include carbon steel alloys of bismuth, boron, chromium, copper, lead, manganese, molybdenum, silicon, nickel, sulfur, titanium, aluminum, tungsten, vanadium or any combination thereof. In further examples, the first material can include carbon fiber or carbon fiber reinforced composites.

The second material can be, for example, a grade of carbide having a strength and hardness higher than steel. The carbide can be a cemented carbide that includes a metallic binder. In some examples, the carbide is at least one of tungsten carbide, chromium carbide, molybdenum carbide, vanadium carbide, titanium carbide, niobium carbide, tantalum carbide, and zirconium carbide. The carbide can be at least one of tungsten carbide, chromium carbide, molybdenum carbide, and vanadium carbide.

The first material and second material can have different material properties. For example, the density of the first material can be higher than the density of the second material. In other examples, the density of the first material can be lower than the density of the second material. The difference between the density of the first material and the density of the second material can be at least about 0.1 g/cm³, about 0.5 g/cm³, about 1 g/cm³, about 2 g/cm³, about 3 g/cm³, about 4 g/cm³, about 5 g/cm³, about 6 g/cm³, about 7 g/cm³, about 8 g/cm³, about 10 g/cm³, about 11 g/cm³, about 12 g/cm³, about 13 g/cm³, about 14 g/cm³, about 15 g/cm³, about 16 g/cm³, about 17 g/cm³, about 18 g/cm³, about 19 g/cm³, or about 20 g/cm³.

In additional examples, the tensile strength of the first material can be higher than the tensile strength of the second material. Additionally, and alternatively, the tensile strength of the first material can be lower than the tensile strength of the second material. The difference between the tensile strength of the first material and the tensile strength of the second material can be at least about 10 MPa, about 50 MPa, about 100 MPa, about 200 MPa, about 300 MPa, about 400 MPa, about 500 MPa, about 600 MPa, about 700 MPa, about 800 MPa, about 900 MPa, about 1000 MPa, or about 1100 MPa.

In further examples, the hardness of the first material can be higher than the hardness of the second material. Additionally, and alternatively, the hardness of the first material can be lower than the hardness of the second material. The difference between the hardness of the first material and the hardness of the second material can be at least about 500 HV, about 550 HV, about 600 HV, about 650 HV, about 700 HV, about 750 HV, about 800 HV, about 850 HV, about 950 HV, about 1000 HV, about 1050 HV, about 1100 HV, about 1150 HV, about 1200 HV, about 1250 HV, about 1300 HV, about 1350 HV, about 1450 HV, about 1500 HV, about 1550 HV, about 1600 HV, about 1650 HV, about 1700 HV, about 1750 HV, about 1800 HV, about 1850 HV, about 1900 HV, about 1950 HV, about 2000 HV, about 2050 HV, about 2150 HV, about 2200 HV, about 2250 HV, about 2300 HV, about 2350 HV, about 2400 HV, about 2450 HV, about 2500 HV, about 2550 HV, about 2600 HV, about 2650 HV, about 2700 HV, about 2750 HV, about 2800 HV, about 2850 HV, about 2900 HV, about 2950 HV, about 3000 HV, about 3050 HV, about 3100 HV, about 3150 HV, about 3200 HV, about 3250 HV, about 3300 HV, about 3350 HV, about 3400 HV, about 3450 HV, or about 3500 HV. In some examples the first material has a hardness of about 500 HV and the second material has a hardness of no more than 3500 HV.

The tips 222 can be formed separately and later joined to the base component. For example, the tips 222 can be fastened to the body 232 through welding or brazing. In other examples, the tips 222 can be (optionally) fastened to the body 232 by a mechanical fastener 235 (e.g., a set screw). It is further contemplated that the tips 222 can be removably fastened to the body 232 by the mechanical fastener. Additionally, or alternatively, the punch 200 can be formed where the tips 222 are integrally formed with the body 232, for example by additive manufacturing or molding processes.

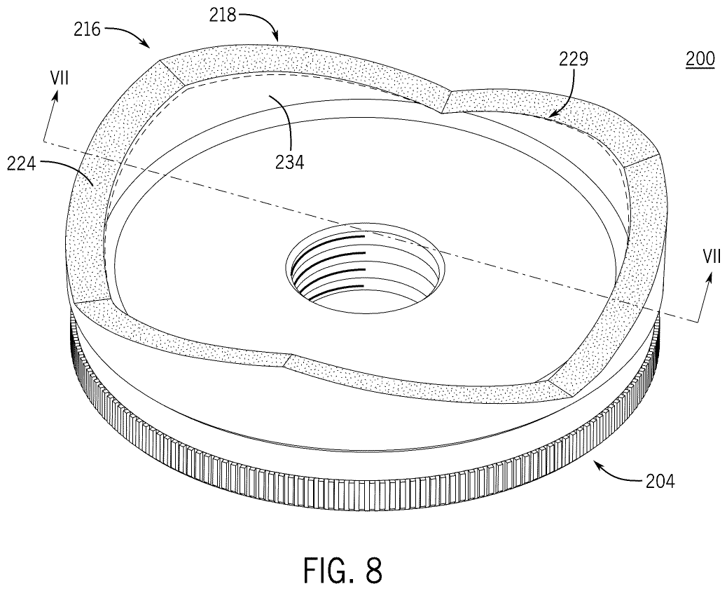

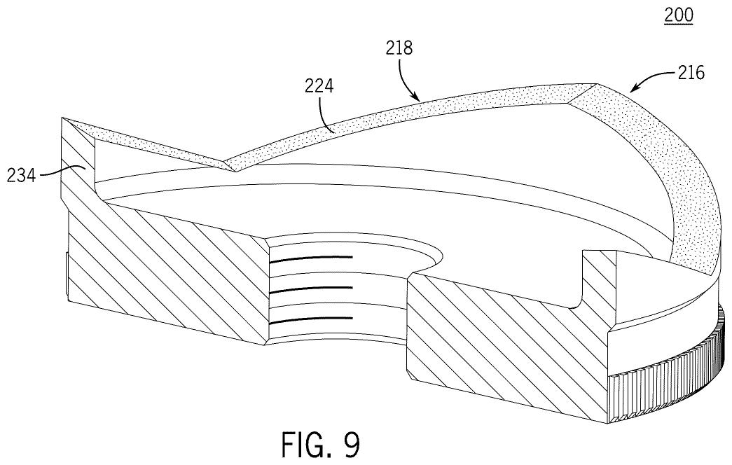

In other examples, tooth 216 materials can be arranged differently. For example, FIGS. 8 and 9 illustrate another example of a tooth 216, wherein a second, wear resistant material is provided as a top layer 224 as the cutting surface (e.g., angled surfaces 218) of the tooth 216. More specifically, the bottom component 230 of the tooth 216 includes the first material as a bottom layer 234 (e.g., a first layer). The top layer 224 (e.g., a second layer) can be coupled to the bottom layer 234 to form the cutting surface (e.g., angled surfaces 218). The bottom layer 234 supports the top layer 224 on the base 204. The bottom layer defines the base 204. In some cases, the base 204 includes the hole 210 that is threaded and threadably engages the second end 166 of the draw stud 160. The tooth 216 extends in the direction of the axis 157 and toward the die 150 when the punch 200 is coupled to the draw stud 16.

In some examples, the top layer 224 can be coupled to the bottom layer 234 via a cladding process (e.g., as a coating). In one example, the cladding process can include pouring melted cladding material (e.g., tungsten carbide, m2 steel, cutting steel, powders with carbide forming additives, etc.) onto the bottom layer 234 to form the top layer 224. In another example, the cladding process can include using a spray gun to apply cladding material to the bottom layer 234 to form the top layer 224.

In further examples, the top layer 224 can be formed by a laser cladding process. In this approach, a cladding material is deposited onto the bottom layer 234. The cladding material can be deposited as a wire or as a powder. In some examples, the cladding material can include a metal-based powder, such as an iron-based powder, a cobalt-based powder, a nickel-based powder, or any combination thereof. In further examples, the cladding material can be a combination of the metal-based powder with a carbide powder. Additionally, or alternatively, the cladding material can include AISI M2 steel, (e,g, a tungsten-molybdenum high speed steel), carbide steel, or cutting steel.

After it is deposited, the cladding material is melted to form the top layer 224 using a heat source. The heat source can be a laser, electric arc, a combustion flame, or heating via an induction coil. Additionally, the cladding material can be melted by placing the workpiece in a furnace or a salt bath. In some cases, the cladding material is melted as it is deposited.

Upon melting, a metallurgical bond is created between the carbide material and the bottom layer 234. The thickness of the top layer 224 can be about 0.1 mm, 0.2 mm, about 0.3 mm, 0.4 mm, about 0.5 mm, about 0.6 mm, about 0.7 mm, about 0.8 mm, about 0.9 mm, about 1 mm, about 1.5 mm, about 2 mm, about 2.5 mm, or about 3 mm. The carbide material of the top layer 224 can include tungsten, cobalt, iron, nickel, chromium, molybdenum, vanadium, titanium, tantalum, niobium, hafnium, or zirconium, or combinations thereof.

In some examples (see e.g., FIG. 8), a buffer layer (e.g., a third layer) can be provided between the top layer 224 and the bottom layer 234. For example, as shown in FIG. 8, a buffer layer 229 can be, for example, nickel. In some cases, the bottom layer 234 can be provided with the buffer layer 229 before the top layer 224 is applied to form the angled surfaces 218. As discussed in further detail below, the bottom layer 234 can be manufactured with a geometry that allows for the top layer 224 to be precisely deposited.

In some examples, the punch 200 can be heat treated after the material is applied to the bottom layer 234. Such heat treatment can improve the hardness of the top layer 224 or the bottom layer 234. Heat treatment can be used to achieve a specific hardness level. Additionally, and alternatively, heat treatment in the case of powder spray processes can densify and fuse the coating to the substrate. In some examples, heat treatment can be used to remove the heat affected zone produced by the cladding process.

The structure of the bottom layer 234 can be varied to improve the bonding of the top layer 224 and help provide uniform strength to the top layer 224. For example, a retaining feature can be added (e.g., to the edge of the angled surface 218) to increase the surface area and thereby improve retention of the melted cladding material, increasing the retention and durability of the cutting edge. Retaining features can include protrusions or cutouts, grooves, knurling, or other features that can improve joint strength. Retaining features can be formed in a base material (e.g., the bottom layer 234), or in a wear-resistant material (e.g., the top layer 224) . . .

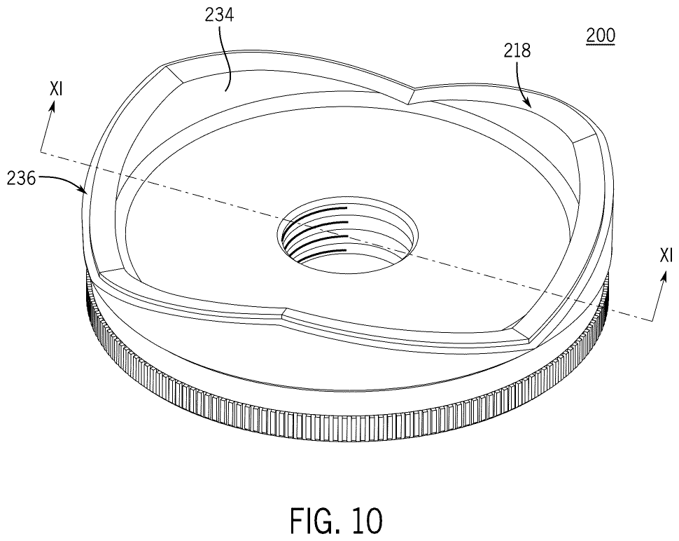

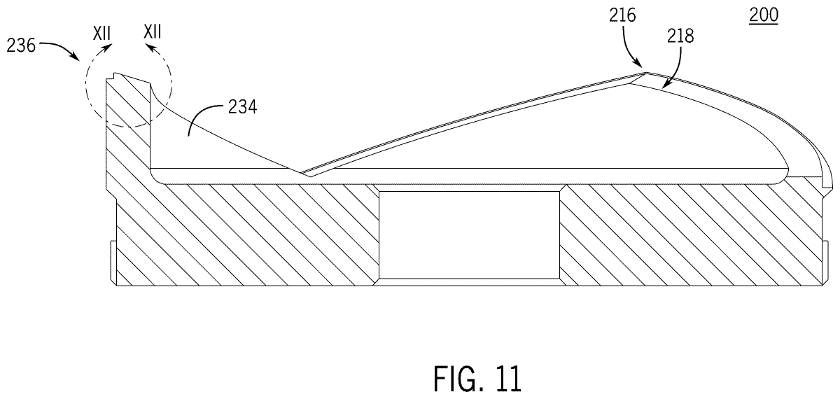

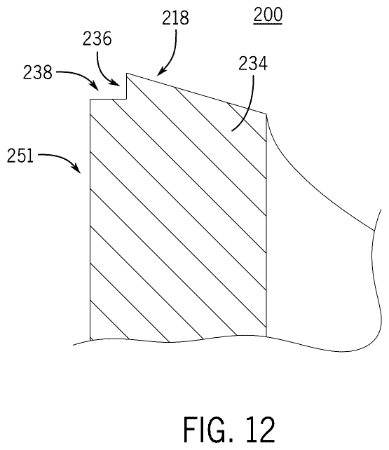

FIGS. 10-12 illustrates one example of a bottom layer 234 with a retaining feature 236 that increases the surface area of the angled surface 218. The retaining feature 236 extends as a step 238 between the angled surface 218 and the outer surface 251. The step 238 increases the surface area of the bottom layer 234 thus improving the bonding between the carbide layer and the bottom layer 234. In some examples, the retaining feature 236 can include two or more steps. In other examples, the retaining feature 236 can include grooves or ridges.

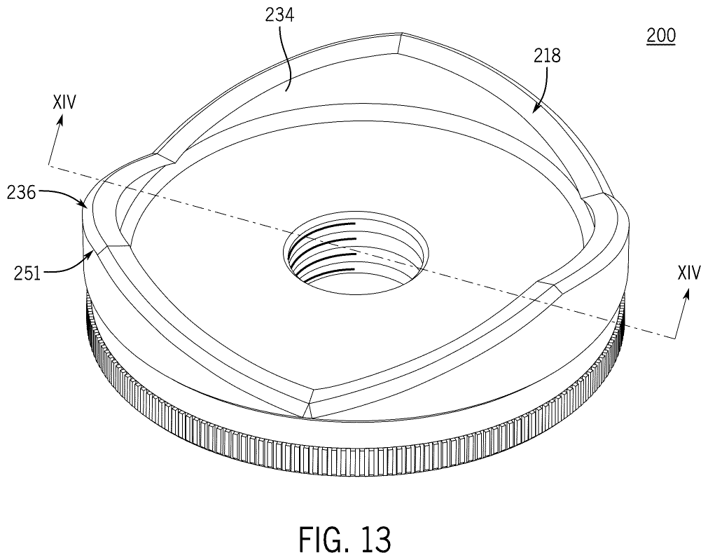

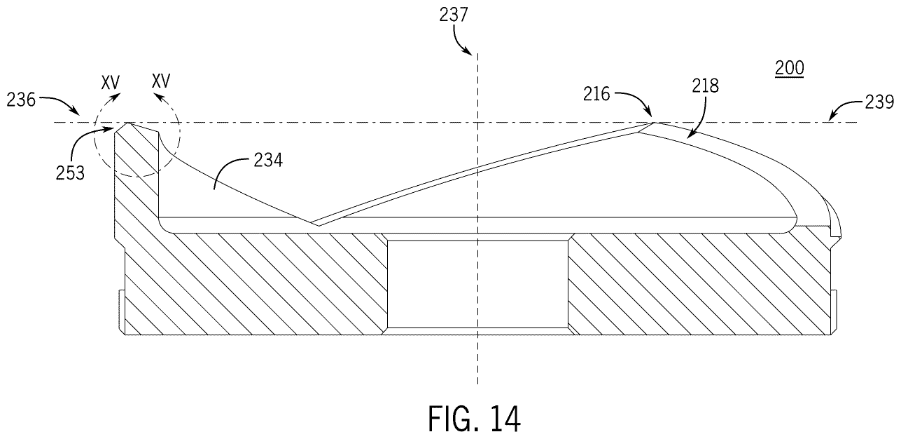

FIGS. 13-15 illustrate another example of a bottom layer 234 with a differently configured retaining feature 236. The retaining feature 236 is a chamfered surface extending between an outer surface 251 and the angled surface 218. The chamfered surface can be planar. For reference, the hole 210 in the base 204, which receives the draw stud 160, defines an axis 237. The punch 200 further defines a plane 239 (e.g., a contact plane) that is orthogonal to the axis 237. The plane 239 may intersect a tip of one or more teeth 216 of the punch 200. The retaining feature 236 can define a first chamfered surface 253 at a first angle 240 between the retaining feature 236 and plane 239 can be between 30° and 90°. The first chamfered surface 253 surface is a radially outer chamfer.

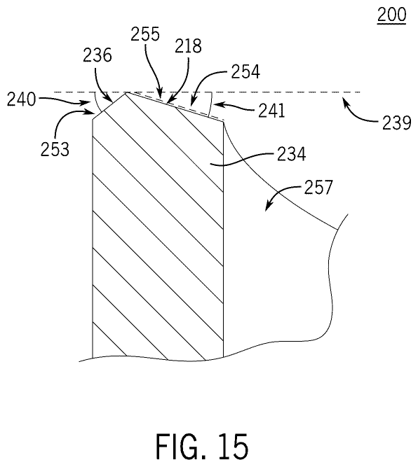

In some cases, a punch 200 may optionally define a second chamfer. For example, still referring to FIG. 15, the punch 200 defines a second chamfer 254 extending between an inner surface 257 and the first chamfered surface 253. A second chamfered surface 255 is a radially inner chamfer. The second chamfered surface 255 defines a second angle 241 between the second chamfer 254 and plane 239. In some examples the first angle and the second angle may be the same (e.g., of the same magnitude). In other examples the first angle and the second angle may be different. Additionally, or alternatively, the retaining feature 236 can be shaped differently, for example, to be a concave surface, or to include castellations, grooves, ribs, etc.

The punch 200 including a combination of two materials as disclosed herein can reduce component wear and improve durability and lifetime of the punch as compared to conventional single material punches.

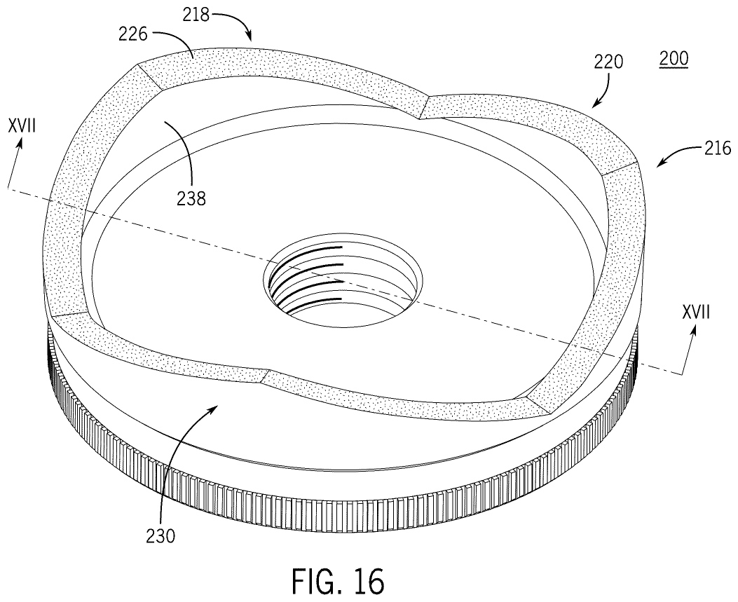

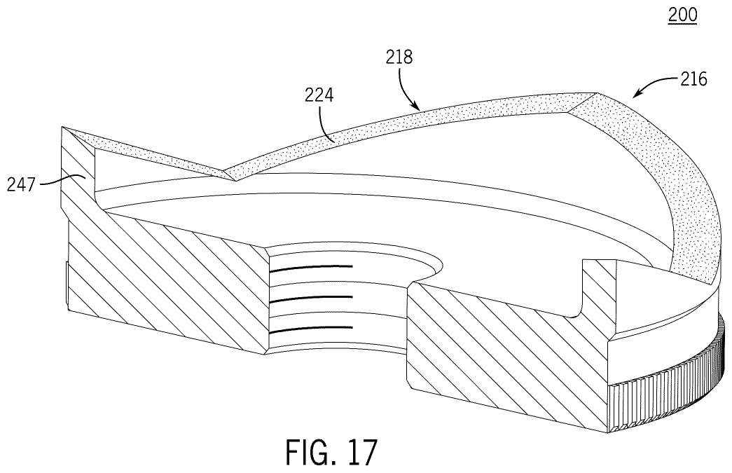

In another example as shown in FIGS. 16-17, the top component 220 includes a hardened layer 226 as the angled surface 218. The bottom component 230 is provided as a substrate 247 for the hardened layer 226. In this embodiment, the substrate 247 and the teeth 216 of the punch 200 are formed from the first material. The hardened layer 226 is characterized by a hardness different from that of the first material. For example, the hardness can be different by more than 1 HRC. In some examples, where the bottom component is GBT 40Cr steel, the hardness of the bottom component can be between 45 HRC and 55 HRC while the laser hardened layer can be between 53 HRC and 63 HRC. In other examples, alternative steel grades can be hardened to a hardness greater than 63 HRC. The range in the laser hardened layer is determined by the tempering temperature used after laser hardening. The hardened layer 226 can have a tensile strength that is different from the first material.

The hardened layer 226 can be formed on the substrate 247 by precisely localized hardening techniques. For example, laser hardening, flame hardening, induction hardening, or electron beam hardening can be used to form the hardened layer 226. These processes allow the hardened layer 226 to be formed selectively in desired regions of the punch 200. For example, the hardened layer 226 can form the entirety of the angled surfaces 218. Additionally, and alternatively, the hardened layer 226 can form portions of the angled surfaces 218 (e.g., regions that are most prone to wear such as along the cutting edges or vertexes of the teeth 216).

The hardened layer 226 is formed on the substrate 247 by a heating/quenching process. In one example process, the first material of the substrate 247 is transformed by application of heat to raise the temperature above the austenitizing temperature followed by self-quenching to form a hardened state having a martensitic microstructure. For example, a laser can be used to selectively heat specific regions of the substrate 247 to between about 900° C. to about 1400° C. After cooling, the hardened layer 226 can be between about 0.1 millimeter to about 3.5 millimeters in depth. In some examples, the hardened layer 226 can have a different thickness, for example, from 0.25 mm to 3.5 mm thick. The hardness of the hardened layer 226 can be a gradient, where the hardness decreases with increasing depth. For example, the hardness at the surface of the hardened layer 226 can be substantially greater than the hardness at a 1 mm depth, a 5 mm depth, or a 10 mm depth.

The substrate 247 is a manufactured component with a retaining feature 236 as previously described, that allows for laser hardening to form the angled surfaces 218 in an efficient, precise way. Advantageously, this design provides precision in the location of the hardening, reduced component wear, and improved part durability.

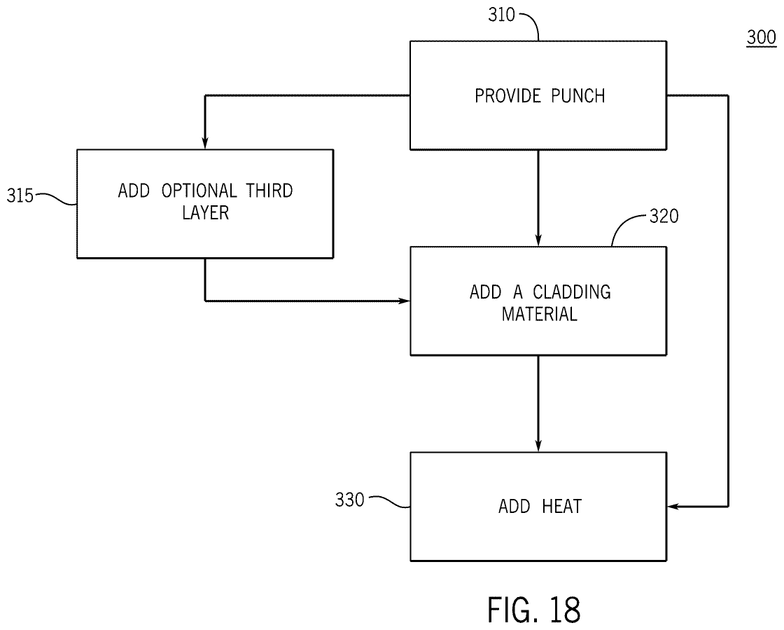

The punch 200 as disclosed herein can be formed according to various methods 300. Generally, as illustrated in FIG. 18, a punch 200 can be provided at operation 310 with a bare or untreated bottom layer 234 or substrate 247. In some examples, an optional third layer can be applied to the untreated bottom layer 234 at operation 315 before the cladding material is applied at operation 320. At operation 330, heat is applied to the cladding material atop the bottom layer 234. In some examples, at operation 330, heat is applied directly to the substrate 247.

The description of the different advantageous embodiments has been presented for purposes of illustration and description and is not intended to be exhaustive or limited to the embodiments in the form disclosed. Many modifications and variations will be apparent to those of ordinary skill in the art. For example, the top layer 224 can be combined with the hardened layer 226 to form a cutting edge. In another example, the tip 222 can include a top layer 224 and/or a hardened layer 226. Further, different advantageous embodiments may provide different advantages as compared to other advantageous embodiments.

The embodiment or embodiments selected are chosen and described in order to best explain the principles of the embodiments, the practical application, and to enable others of ordinary skill in the art to understand the disclosure for various embodiments with various modifications as are suited to the particular use contemplated.

Additionally, the use of “including,” “comprising,” or “having” and variations thereof herein is meant to encompass the items listed thereafter and equivalents thereof as well as additional items. Unless specified or limited otherwise, the terms “mounted,” “connected,” “supported,” “attached,” and “coupled” and variations thereof are used broadly and encompass both direct and indirect mountings, connections, supports, and couplings.

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A punch assembly, comprising:
a draw stud defining a first end, a second end opposite the first end, and an axis extending along the draw stud in a direction between the first end and the second end;
a die having a first cross-sectional shape taken perpendicular to the draw stud, the die coupled to the draw stud so that the draw stud is moveable relative to the die along the axis; and
a punch coupled to the draw stud and moveable with the draw stud relative to the die, the punch having a second cross-sectional shape corresponding to the first cross sectional shape so that the punch moving past the die causes a punch in a workpiece, the punch including:
a base including a first material, and
a plurality of teeth extending from the base, each of the plurality of teeth having a body including a first material and a tip including a second material that has a material property that is different from the first material.

2. The punch assembly of claim 1, wherein the first material has a hardness, density, or tensile strength that is different from the second material.

3. The punch assembly of claim 1, wherein the plurality of teeth includes an angled surface that engages a workpiece.

4. The punch assembly of claim 3, wherein the angled surface includes a radially outermost edge that defines a cutting edge.

5. The punch assembly of claim 1, wherein the tip is metallurgically joined with body.

6. The punch assembly of claim 1, wherein the second material is a hardened form of the first material.

7. The punch assembly of claim 6, wherein the second material is laser hardened, flame hardened, induction hardened, or electron beam hardened.

8. The punch assembly of claim 1, wherein the first material includes a hardenable steel alloy that includes at least one of carbon steel, boron steel, alloy steel, or tool steel.

9. The punch assembly of claim 1, wherein the first material includes carbon fiber.

10. The punch assembly of claim 1, wherein the second material comprises carbide including at least one of tungsten carbide, chromium carbide, molybdenum carbide, vanadium carbide, titanium carbide, niobium carbide, tantalum carbide, hafnium carbide, or zirconium carbide.

11. A punch assembly comprising:
a draw stud defining a first end including a coupler, a second end that is threaded and positioned opposite the first end, and an axis extending along the draw stud in a direction between the first end and the second end;
a die defining a recess having a first cross-sectional shape taken perpendicular to the draw stud, the die coupled to the draw stud so that the draw stud is moveable relative to the die along the axis;
a collar coupled to the second end of the draw stud; and
a punch coupled to the draw stud so that the die is between the punch and the collar, the punch moveable with the draw stud relative to the die so that punch is received in the recess of the die to cause a punch in a workpiece, and the punch including:
a bottom layer including a first material, the bottom layer defining a base having a threaded opening that threadably engages the second end of the draw stud, and a plurality of teeth extending in the direction of the axis and toward the die when the punch is coupled to the draw stud; and
a top layer coupled to the bottom layer, the top layer defining an angled surface that engages with a workpiece, and the top layer including a second material having a material property that is different from the first material.

12. The punch assembly of claim 11, wherein the top layer is coupled the bottom layer via a cladding material.

13. The punch assembly of claim 12, wherein the cladding material is a metal powder.

14. The punch assembly of claim 11 further comprising a buffer layer positioned between the top layer and the bottom layer.

15. The punch assembly of claim 14, wherein the buffer layer is nickel.

16. The punch of claim 11, wherein the first material has at least one of a hardness, density, and tensile strength that is different from the second material.

17. A power tool for performing a punch in a workpiece having a first side and a second side, the power tool comprising:
a tool body including a housing, a motor received in the housing, an actuator supported by the housing and operable by the motor, the actuator including a ram that is movable along an axis between a first position and a second position, the ram including a coupler, and an anvil fixed relative to the housing so that the ram moves relative to the anvil along the axis; and
a punch assembly including:
a draw stud defining a first end that removably couples to the coupler of the ram, a second end opposite the first end, the draw stud moving with the ram between the first position and the second position,
a die coupled to the draw stud so that the draw stud is moveable relative to the die along the axis when the draw stud is braced between the anvil and the first side of the workpiece; and
a punch including a base defining a retaining feature and a plurality of teeth extending from the base, each of the plurality of teeth having a body defining a retaining feature including a first material and a tip coupled at the retaining feature and including a second material that has a material property that is different from the first material,
the punch coupled to the second end of the draw stud so that the plurality of teeth engage the second side of the workpiece, the moving past the die to cause a punch in a workpiece.

18. The power tool of claim 17, wherein the retaining feature includes a first chamfered surface at a first angle.

19. The power tool of claim 18, wherein the retaining feature includes a second chamfered surface extending from the first chamfered surface, the second chamfered surface at a second angle.

20. The power tool of claim 17, wherein the retaining feature is a concave region.
